(19) United States
(12) Patent Application Publication
(10) Pub. No.: US 2011/0073657 A1
(43) Pub. Date: Mar. 31, 2011

(54) METHOD AND APPARATUS FOR DETECTING A BARCODE

(76) Inventors: Miroslav Trajkovic, Centereach, NY (US); Dariusz Madej, Shoreham, NY (US)

(21) Appl. No.: 12/570,152

(22) Filed: Sep. 30, 2009

(51) Int. Cl. G06K 7/10

(52) U.S. Cl. 235/462.41; 235/462.25

(57) ABSTRACT

A method and apparatus for detecting a barcode like region contained in a target object. The method includes capturing an image of the target object, calculating a total confidence value for the captured image, and determining a presence of a barcode in the captured image based on the total confidence value, wherein the total confidence value is calculated as a function of at least one of a first, second, and third confidence values. The method of calculating the confidence values includes calculating the first confidence value based on a vertical projection signal of the barcode like region in the captured image, the second confidence value based on a horizontal projection signal of the barcode like region in the captured image, and the third confidence value based on a start and stop pattern of the barcode like region in the captured image.

### FIELD OF THE DISCLOSURE

The present disclosure relates generally to electro-optical system and more particularly to a method and apparatus for detecting a barcode.

### BACKGROUND

A barcode is a coded pattern of graphical indicia used for optical machine-readable data representation. The barcode comprises a series of bars and spaces of varying widths, the bars and spaces having differing light reflecting characteristics. Barcodes may be one dimensional (1D), i.e., a single row of graphical indicia such as a UPC barcode or two dimensional (2D), i.e., multiple rows of graphical indicia comprising a single barcode such as a PDF 417 barcode.

Systems that read barcodes called barcode readers electro-optically transform the graphic indicia into electrical signals and then decode the electric signals into alphanumerical characters that are intended to be descriptive of the article or some characteristic thereof. However, in some situations when the barcode is obtained at low lighting (i.e. high noise) and low resolution (below 1 ppm (pixels per module)), the barcode readers will have a limited decodable range due to blur and resolution limit. In such situations there is a need to at least detect the presence of the barcode.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of barcode system in accordance with some embodiments.

FIG. 2 is a flowchart of a method for detecting a barcode in accordance with some embodiments.

FIG. 3 is a schematic of a 2D barcode in accordance with some embodiments.

FIG. 4 is a graphical representation of a vertical projection signal in accordance with some embodiments.

FIG. 5 is a graphical representation of a horizontal projection signal in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention relates to a method and apparatus for detecting a barcode like region contained in a target object. The method includes capturing an image of the target object, calculating a total confidence value for the captured image, and determining a presence of a barcode in the captured image based on the total confidence value. The total confidence value is calculated as a function of at least one of a first, second, and third confidence values. The method of calculating the confidence values includes calculating the first confidence value based on a vertical projection signal of the barcode like region in the captured image, the second confidence value based on a horizontal projection signal of the barcode like region in the captured image, and the third confidence value based on a start and stop pattern of the barcode like region in the captured image. Advantages of the various embodiments include: detecting the presence of a barcode under blurred and low resolution conditions by just detecting some human recognizable features that are less variant to blur and resolution limit. Those skilled in the art will realize that the above recognized advantages and other advantages described herein are merely illustrative and are not meant to be a complete rendering of all of the advantages of the various embodiments.

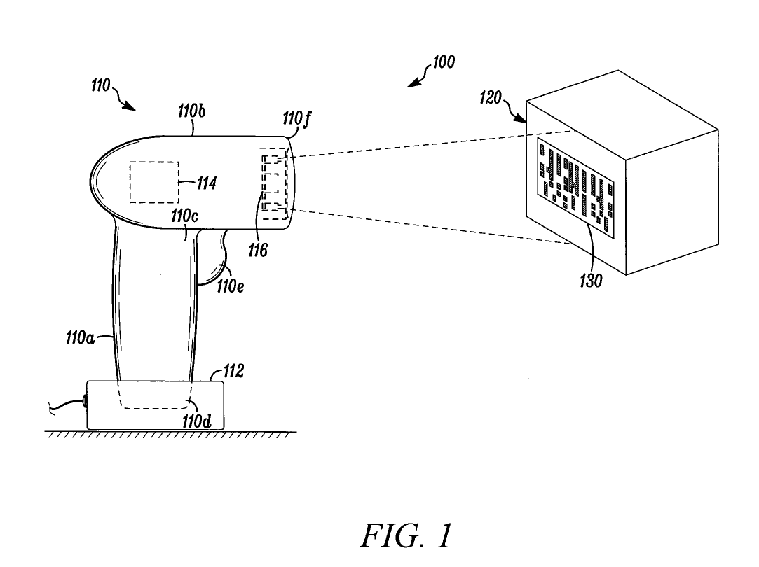

Referring now to figures, FIG. 1 is a block diagram of a barcode system 100 in accordance with some embodiments. The barcode system 100 can include such as, but not limited to an imaging-based barcode system. FIG. 1, system 100 shows a hand-held barcode reader 110 acting upon a target object 120 having a barcode 130. The barcode 130 can include such as but not limited to the popular barcode symbologies such as: Uniform Product Code (UPC), typically used in retail stores sales; Code 39, primarily used in inventory tracking; Postnet, which is used for encoding zip codes for U.S. mail; and PDF 417 barcodes, which is used in driving licenses. Barcodes may be one dimensional (1D), i.e., a single row of graphical indicia such as the UPC barcode or two dimensional (2D), i.e., multiple rows of graphical indicia comprising a single barcode such as the PDF 417 barcode.

Returning back to the description of FIG. 1, the hand-held barcode reader 110 includes a gripping portion 110a adapted to be grasped by an operator's hand and a forward or scanning head portion 110b extending from an upper part 110c of the gripping portion 110a. A lower part 110d of the gripping portion 110a is adapted to be received in a docking station 112 positioned on a substrate such as a table or sales counter. The barcode reader 110 includes a front wall region 110f on the scanning head portion 110b. The scanning head portion 110b includes an imaging system 116 including a camera assembly (not shown) and an illumination apparatus (not shown). The camera assembly includes one or more imaging lens and a photo sensor or pixel array for capturing the image of the barcode 130 through a transparent window (not shown) present on the front wall 110f. The barcode reader 110 also includes a trigger 110e. Imaging and decoding of the target barcode 130 is instituted by depressing the trigger 110e.

The barcode reader 110 of the present invention is adapted to be used in both a hand-held mode and a fixed position mode. In the fixed position mode, the reader 110 is received in the docking station 112 and a target object 120 having a target barcode 130 is brought within the field of view (FoV) of the imaging system 116 in order to have the reader 110 read the target barcode 130. In the hand-held mode, the reader 110 is removed from the docking station 112 so the reader 110 can be carried by an operator and positioned such that the target barcode 130 is within the field of view FoV of the imaging system 116. In the hand-held mode, imaging and decoding of the target barcode 130 is instituted by the operator depressing the trigger 110e.

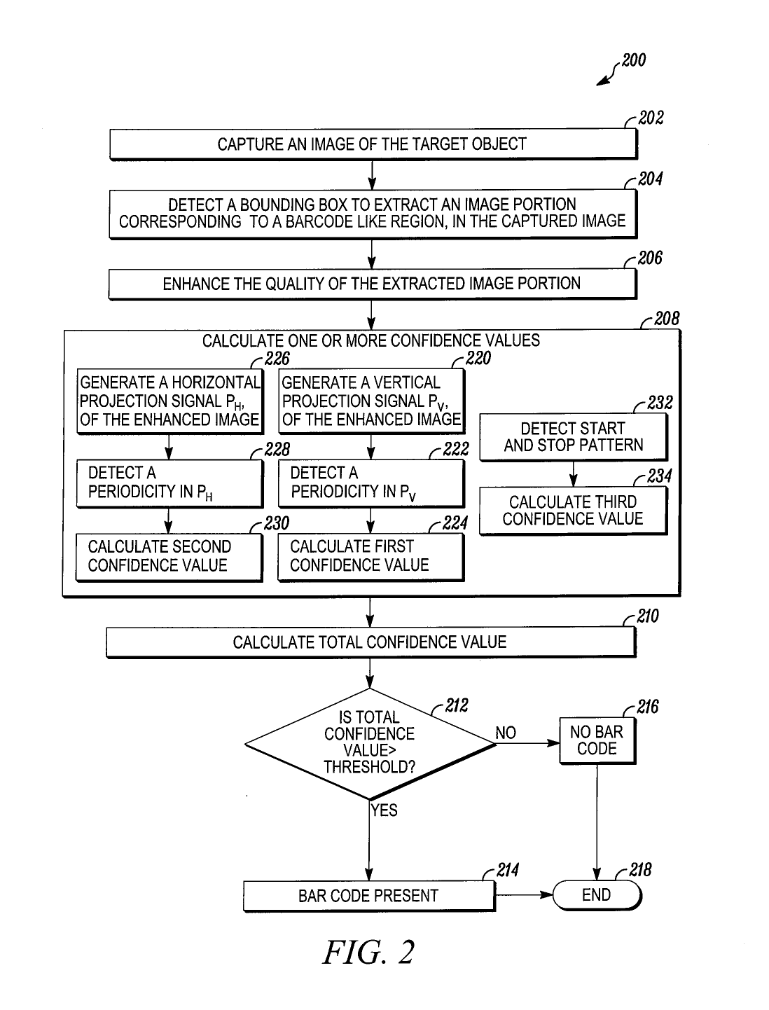

Referring back to the barcode reader 110, the reader 110 also includes a decoding system 114. The decoding system 114 comprises a microprocessor operating on the image captured by the imaging system 116 and detecting a presence of the barcode in the target object. The microprocessor is programmed to calculate a first, second, and third confidence values and a total confidence value as explained below with reference to FIG. 2. Further, the microprocessor is programmed to determine the presence of the barcode 130 in the target object 120 by comparing the total confidence value with a predetermined threshold value and indicate the result to a user via a display device such as a monitor or a LED or using a speaker.

The imaging 116 system and decoding 114 system of the present invention may be embodied in hardware, software, electrical circuitry, firmware embedded within the microprocessor or the imaging camera assembly, on a flash read only memory (ROM), on an application specific integrated circuit (ASIC), or any combination thereof

FIG. 2 is a flow diagram of a method 200 in accordance with some embodiments. Method 200 provides the steps needed for determining the presence of a barcode 130 in a target object 120.

The method can be implemented in a microprocessor (not shown) present in the decoding system 114 of the barcode reader 110. The method starts with capturing 202 an image of the target object 120. The target object 120 can be a document such as a driving license, identity card, etc., including a barcode 130 such as a PDF 417 barcode. PDF 417 barcode symbol is a two dimensional barcode with a plurality of rows and columns. A typical PDF 417 bar code can include 3-90 rows and 1-30 columns and can represent up to 1.1 kilobytes of machine-readable data. The data can include such as but not limited to biometric data files containing photographs, fingerprints, and signatures, text, numbers and graphics.

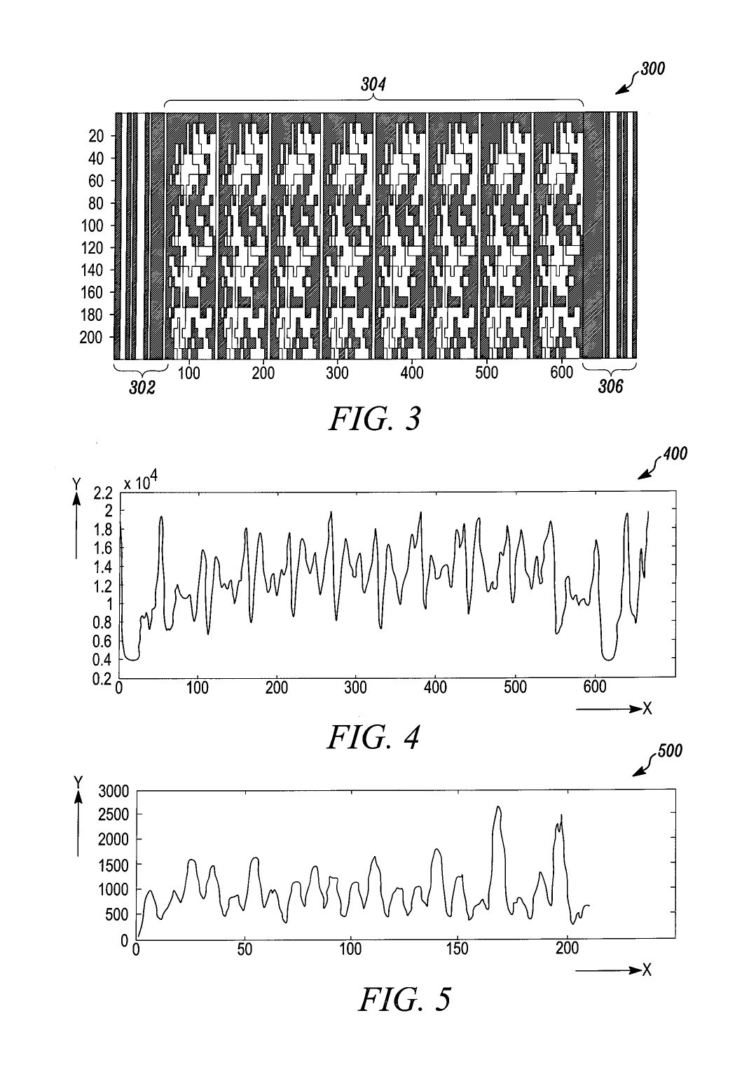

Returning back to the method 200, upon capturing 202 the image the method 200 proceeds with detecting 204 a bounding box over a barcode like region in the captured image. The bounding box helps in extracting an image portion corresponding to the barcode like region in order to enable processing on a specific area of the target object 120 and not the entire target object 120. The method 200 continues with enhancing 206 the quality of the extracted image portion. The enhancing 206 can be achieved by applying image filtering or rectifying process on the extracted image portion, as is already known in the art. The enhanced or rectified image 300 is shown in FIG. 3. The rectified image 300 represents a plurality of pixel values arranged in rows and columns. Further, the rectified image 300 includes a first region 302 indicating a start pattern of the PDF barcode 130, a second region 304 indicating rows and columns of the PDF barcode 130, and a third region 306 indicating a stop pattern of the PDF barcode 130.

Referring back to FIG. 2, once the rectified or the enhanced image 300 is obtained the method 200 continues with calculating 208 one or more confidence values. The confidence values are calculated based on certain human readable features present in the barcode that are fairly invariant to blur and resolution limit. The features include at least one of a start and stop pattern of the barcode, edges between rows in a barcode, and edges between columns in a barcode, which are easily identifiable by a human being from some distance.

The method 200, wherein calculating 208 one or more confidence values further includes calculating a first confidence value 224, a second confidence value 230, and a third confidence value 234. The first confidence value is calculated by first generating 220 a vertical projection signal (Pv) 400 as is shown in FIG. 4. FIG. 4 is a graphical representation of a vertical projection signal 400 in accordance with some embodiments. The X axis of the vertical projection signal 400 represents column numbers of the rectified image 300 and Y axis represents the corresponding projected pixel values.

Turning back to FIG. 2, there are various known methods to generate 220 the vertical projection signal 400. In accordance with one embodiment of the present invention the vertical projection signal 400 is generated by adding cumulatively, pixel values at a plurality of continuous pixel positions in columns of the enhanced image portion 300.

Upon generating 220 the vertical projection signal 400 the method 200 proceeds with detecting 222 a periodicity in the vertical projection signal 400 and then calculating 224 the first confidence value based on the detection. There are various methods for detecting a periodicity in a signal. In one embodiment, the existence of a periodicity can be determined with a method that includes applying Fourier transform on a signal to obtain a spectrum of the signal and looking for harmonics in the spectrum. In another embodiment, the existence of periodicity can be detected using Cepstrum technique and looking for a maximum. In one another embodiment, existence of a periodicity can be determined using a hypothesis testing method. In one example, the hypothesis testing method can include (1) testing for all possible periods in a signal by making an assumption on the number of columns in the initial image (e.g., a barcode image), (2) applying a correlation function on all the possible periods, and (3) selecting a period that has a maximum correlation value. In accordance with one embodiment, the first confidence level is calculated by predicting the position of edges for a given number of columns (k) and calculating the confidence level c(k) as a function of the height of the edges as

$$c ( k ) = \frac{1}{k} {\sum }_{i = 1}^{k} height\_of \_edge \_at \_position \_i$$

In the above equation the height of each edge is normalized to take a value between 0 and 1, and consequently c(k) takes a value between 0 and 1.

Referring back to calculating 208 one or more confidence values, the second confidence value is calculated by first generating 226 a horizontal projection signal (Pₕ) 500 as is shown in FIG. 5. FIG. 5 is a graphical representation of the horizontal projection signal 500 in accordance with some embodiments, where the X axis represents row numbers of image 300 and Y axis represents absolute values of vertical gradients along the row, wherein the vertical gradient is defined as the difference between neighboring pixels in vertical direction along the row.

Referring again to FIG. 2, there are various methods to generate 226 the horizontal projection signal 500. In accordance with one embodiment of the present invention the horizontal projection signal 500 is generated by adding cumulatively, absolute values of vertical gradients at a plurality of continuous pixel positions along the rows of the enhanced image portion 300. The horizontal projection signal 500 is a periodic function where the peaks in the horizontal projection signal correspond to the edges between rows of code words in the PDF 417 barcode 130 and valleys correspond to the middle of the rows of code words in the barcode 130.

Upon generating 226 the horizontal projection signal 500 the method 200 proceeds with detecting 228 a periodicity in the horizontal projection signal 500 by using one of the above mentioned techniques and then calculating 230 the second confidence value based on the detection. In one embodiment, the second confidence value is estimated in the following manner. Upon detecting 228 a periodicity, the method proceeds with estimating a function period (average distance between peaks) and a phase value (the first peak), and forming an auxiliary function ‘f’ for the horizontal projection signal 500. The auxiliary function ‘f’ has a value of ‘1’ in the peak location and a value of ‘−1’ at the valley location. The second confidence value is then calculated as a cross-correlation between the horizontal projection signal 500 and the auxiliary function f.

Further, referring to the calculation 208 of confidence values the third confidence value is calculated by first detecting 232 a start and stop pattern in the enhanced image 300 and then performing a cross-correlation between the detected start and stop pattern and a start and stop pattern of an ideal barcode. The result of the cross-correlation corresponds to the third confidence value.

Referring back to the method 200, upon calculating 208 one or more confidence values a total confidence value is calculated 210 as a function of at least one of the above mentioned first, second, and third confidence values. In one example, the total confidence value can be calculated as a product of the first, second, and third confidence values. In another example the total confidence value is calculated as a sum of products of the first and second confidence values, second and third confidence values, and first and third confidence values. In one another example the total confidence value can be calculate based on any function performed on the first, second, and third confidence values by taking the values either individually or in combination with others. The total confidence value is then compared 212 with a predetermined threshold value, wherein the predetermined threshold can be determined experimentally for a given scanner design. If the total confidence value is greater than a predetermined threshold then an indication is sent to the user of the barcode reader 110 that a barcode is present 214 in the target object 120 and the method ends at 218. If the total confidence value is less that the threshold then an indication is sent to the user that there is no barcode present 216 in the target object 120 and the method ends at 218. The user can be indicated in various ways either using a visual indicator such as but not limited to a monitor, LED, etc., or an audio indicator such as but not limited to a speaker.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for detecting a barcode like region contained in a target object, the method comprising:
capturing an image of the target object;
calculating a first confidence value based on a vertical projection signal of the barcode like region in the captured image, a second confidence value based on a horizontal projection signal of the barcode like region in the captured image, and a third confidence value based on a start and stop pattern of the barcode like region in the captured image;
calculating a total confidence value as a function of at least one of the first, second, and third confidence values; and
determining a presence of a barcode in the captured image based on the total confidence value.

2. The method of claim 1, wherein the barcode like region is a two dimensional barcode comprising a plurality of rows and columns.

3. The method of claim 2, wherein the barcode is a PDF 417 barcode.

4. The method of claim 1 further comprising:
detecting a bounding box of the bar code like region in the captured image in order to extract an image portion corresponding to the barcode like region;
enhancing the quality of the extracted image portion; and
generating a vertical projection signal and a horizontal projection signal from the enhanced image portion.

5. The method of claim 4, wherein the enhanced image portion is a two dimensional image comprising a plurality of pixel values arranged as rows and columns

6. The method of claim 5 further comprising:
adding cumulatively, pixel values at a plurality of continuous pixel positions in columns of the enhanced image portion to generate the vertical projection signal; and
adding cumulatively, absolute values of vertical gradients at a plurality of continuous pixel positions along the rows of the enhanced image portion to generate the horizontal projection signal.

7. The method of claim 6 further comprising:
detecting a periodicity in the vertical projection signal and a periodicity in the horizontal projection signal; and
detecting a start and stop pattern present in the enhanced image portion.

8. The method of claim 7 further comprising:
calculating the first confidence value based on the periodicity in the vertical projection signal;
calculating the second confidence value based on the periodicity in the horizontal projection signal;
calculating a third confidence value based on the start and stop pattern; and
determining a presence of a barcode in the captured image based on at least one of the first, second, and third confidence values.

9. An apparatus for detecting a barcode like region contained in a target object, the apparatus comprising:
a camera for capturing an image of the target object; and
a processor coupled to the camera, wherein the processor is configured to
calculate a first confidence value based on a vertical projection signal of the barcode like region in the captured image, a second confidence value based on a horizontal projection signal of the barcode like region in the captured image, and a third confidence value based on a start and stop pattern of the barcode like region in the captured image;
calculate a total confidence value as a function of at least one of the first, second, and third confidence values; and
determine a presence of a barcode in the captured image based on the total confidence value.

10. The apparatus of claim 9, wherein the barcode like region is a two dimensional barcode comprising a plurality of rows and columns.

11. The apparatus of claim 10, wherein the processor is further configured to:
detect a bounding box of the bar code like region in the captured image in order to extract an image portion corresponding to the barcode like region;
enhance the quality of the extracted image portion; and
generate a vertical projection signal and a horizontal projection signal from the enhanced image portion

12. The apparatus of claim 11, wherein the enhanced image portion is a two dimensional image comprising a plurality of pixel values arranged as rows and columns.

13. The apparatus of claim 12 wherein the processor is further configured to cumulatively add pixel values at a plurality of continuous pixel positions in columns of the enhanced image portion to generate the vertical projection signal and cumulatively add absolute values of vertical gradients at a plurality of continuous pixel positions along the rows of the enhanced image portion to generate the horizontal projection signal.

14. The apparatus of claim 13, wherein the processor is further configured to:
detect a periodicity in the vertical projection signal and a periodicity in the horizontal projection signal; and
detect a start and stop pattern present in the enhanced image portion.

15. The apparatus of claim 14 wherein the processor is further configured to:
calculate a first confidence value based on the periodicity in the vertical projection signal, a second confidence value based on the periodicity in the horizontal projection signal, and a third confidence value based on the start and stop pattern; and
determine a presence of a barcode in the captured image based on at least one of the first, second, and third confidence values.

16. An imaging-based bar code system for detecting a barcode like region contained in a target object, the system comprising:
a scanning arrangement comprising an imaging assembly for capturing an image of the target object; and
a detection arrangement coupled to the scanning arrangement, wherein the detection arrangement comprises a means for
calculating a first confidence value based on a vertical projection signal of the barcode like region in the captured image, a second confidence value based on a horizontal projection signal of the barcode like region in the captured image, and a third confidence value based on a start and stop pattern of the barcode like region in the captured image,
calculating a total confidence value as a function of at least one of the first, second, and third confidence values, and determining a presence of a barcode in the captured image based on the total confidence value.

17. The system of claim 16, wherein the barcode is a two dimensional barcode comprising a plurality of rows and columns.

18. The system of claim 17, wherein the barcode is PDF 417 barcode.

19. The system of claim 16, wherein the target object comprises a driving license document containing a two dimensional barcode.
